(19) United States
(12) Patent Application Publication
(10) Pub. No.: US 2003/0120922 A1
(43) Pub. Date: Jun. 26, 2003

(54) Device authentication system and method

(75) Inventors: NI Sun, Sunnyvale, CA (US); Collin Connors, San Jose, CA (US); Veronica Alarcon, San Jose, CA (US); Hassan Hanjani, Fremont, CA (US)

Correspondence Address: Philip W. Woo, c/o SIDLEY AUSTIN BROWN & WOOD LLP, SUITE 5000, 555 CALIFORNIA STREET, SAN FRANCISCO, CA, 94104-1715, US

(73) Assignee: Fairchild Semiconductor Corporation

(21) Appl. No.: 10/310,374

(22) Filed: Dec. 4, 2002

Related U.S. Application Data
(60) Provisional application No. 60/337,191, filed on Dec. 6, 2001.

(51) Int. Cl. H04L 9/00

(52) U.S. Cl. 713/168

(57) ABSTRACT

A system and method for device authentication are disclosed. In one embodiment, a random security code is generated during a boot operation to verify authenticity of a device. The random security code may comprise a rolling code based on a static number and a seed number, where the static number does not change between successive boots and the seed number changes between boots. A random number generator algorithm may provide the seed number.

### CROSS REFERENCE TO RELATED APPLICATION

This application is related to and claims priority of U.S. Provisional Patent Application No. 60/337,191, filed Dec. 6, 2001, the disclosure of which is expressly incorporated herein by reference.

### TECHNICAL FIELD

The present system and method relate to programmable systems, and more particularly to a system and method for authenticating a device.

### BACKGROUND

A problem for many designers and producers of programmable systems is that competitors may copy their designs without authorization. Such programmable systems may include hardware and software elements of personal computers, portable electronic devices (e.g., cellular telephones, Personal Digital Assistants (PDAs), portable computers, cameras, camcorders), and electronic gaming systems.

For example, motherboard designs are sometimes copied. Such copying may be accomplished by various means. In some circumstances, a competitor may employ an X-ray device to examine a motherboard and to extract the design thereof. The extracted design may then be used to create a copied, or “cloned,” motherboard. Other means of copying are also conventionally employed.

This copying is undesirable for many designers and producers of original programmable systems for a variety of reasons. One such reason is that sales of the cloned systems may compete in the marketplace with original or authorized programmable systems.

### SUMMARY

A need exists, therefore, for a system and method for providing programmable systems with security features to protect against successful cloning or copying. Another need exists for authenticating a device. In one embodiment, a security code is generated during boot up to verify that system components are authorized components. If the security code generated during boot up matches a stored code, the boot process continues normally. Otherwise, the system may shutdown or may perform some other action to at least partially disable the system.

Pursuant to one embodiment, the security code is a rolling code generated using first and second numbers. The first number may comprise a static, unchanging number, such as a manufacturer ID or a vendor ID unique to a particular manufacturer or vendor, or other number known only to authorized entities, such as the manufacturer or vendor of the programmable system. The second number may comprise a changing number that changes periodically, such as every time the programmable system boots up. The second number may be a random number produced by a random number generator. The second number may also be referred to as a “seed number.” The rolling code, therefore, may comprise combination, such as a mathematical combination, of the first and second numbers. The security code is thus difficult to duplicate because of the changing nature of the security code.

In accordance with some embodiments, a first number and a second number are stored at a first device and the first and second numbers are also stored at a second device. A first code is then generated at the first device using the first and second numbers stored at the first device and a second code is generated at the second device using the first and second numbers stored at the second device. The first and second codes are then compared to determine whether the first code matches the second code. If the first code matches the second code, a third number is generated at the first device and stored at the second device. The third number is optionally also stored at the first device. If the first code does not match the second code, the first device, the second device, or both devices, may shut down or otherwise cease normal operation.

Later, such as during a subsequent boot, the first device generates a third code at the first device using the first and third numbers and the second device generates a fourth code using the first and third numbers. The first device then compares the third and fourth codes to determine whether the third code matches the fourth code. The first device may read the third number from the second device or from the first device before generating the third code.

In one embodiment, the present invention may be implemented in a BIOS (Basic Input Output System) of a programmable system, such as a personal computer motherboard and an associated security driver. The security driver includes a static number and a first seed number. The BIOS also stores the static number and the first seed number. The security driver generates a first security code based on the static number and the first seed number stored at the security driver. Likewise, the BIOS generates a second security code based on the static number and the first seed number stored at the BIOS. According to this embodiment, the BIOS reads the security code from the security driver and compares the first security code with the second security code generated by the BIOS.

If the first and second security codes do not match, the associated programmable system may be an unauthorized clone. Upon determining that the first and second security codes do not match, the BIOS may shut down the programmable system or take some other action to prevent normal, continued system operation. If the BIOS determines that the first and second security codes do match, the BIOS generates a second seed number, such as by using a random number generator algorithm. The BIOS then replaces the previous first seed number stored at the security driver with the second seed number by writing the second seed number to the security driver. The BIOS may also write the second seed number to the BIOS memory. Thus, in the next boot up attempt, new third and fourth security codes based on the static number and the second seed number will be generated at the BIOS and at the security driver, respectively.

In one embodiment, each time the system boots, the BIOS reads the seed number the BIOS wrote to the second device and a second device security code from the second device. Using the static code stored at the first device and the seed number read from the second device, the BIOS computes and generates a first device security code. If the first device security code generated by the BIOS matches the second device security code generated at the second device, then the BIOS permits the system to boot. Otherwise, the BIOS causes the system to power down or cease operation. Moreover, on a successful boot, the BIOS generates and writes a new seed number to the second device.

As mentioned, the programmable system may comprise a personal computer. The programmable system may alternatively comprise a desktop computer, portable electronic devices (e.g., cellular telephones, PDAs, portable computers, cameras, camcorders), electronic gaming systems, or the like.

Moreover, the present system and method may also be used in connection with software keys to prevent unlicensed software use. For example, a software application at a first device generates a first device security code based on a static number stored at the first device and a seed number. A second device, such as a software key generates a second device security code based on a static number stored at the second device and a seed number. The seed number may be stored at the second device or at both the first and second devices. The first device then reads the second device security code and determines whether the first and second security codes match. If the first and second security codes match, the software application runs normally, otherwise, the software application ceases normal operation.

With respect to electronic games, the present system and method may protect game manufacturers from software theft. Many electronic game systems comprise a game console and a removable game cartridge. In this configuration, the removable game cartridge may comprise the first device and the electronic game console may comprise the second device. Thus, the cartridge is initially configured to include a static number and a first seed number. The cartridge then generates a first code number based on the static number and the first seed number. The console then reads the first code number from the cartridge and determines whether the first code number matches a second code number calculated at the console based on a static number stored at the console and a seed number. If the console determines that the first and second codes do not match, the console disables running of the game stored at the cartridge.

With respect to portable electronic devices, the present system and method may protect manufacturers from third-party development and usage of peripherals made specifically for use on their products (e.g., cellular telephone battery chargers). In particular, a product, such as a cellular telephone may comprise the first device and an authorized cellular telephone battery charger may comprise the second device (i.e., a peripheral). If, as described above, security codes generated at the first and second devices do not match, the first device may shutdown or cease to operate with the second device, such as by not recharging using the second device.

In another application, the present system and method may be implemented as an anti-theft mechanism. In one example embodiment, the first device may comprise a central processing unit of a first system. The first system may comprise an automobile and the central processing unit of the first system may comprise an engine control unit (ECU). The second device may comprise a removable card that is selectively connected with the first device. If, as described above, first and second security codes match as the automobile is started, operation of the automobile continues normally. If the removable card is not present or fails to generate a matching security code, the automobile stops the starting process or otherwise operate normally, thus at least partially disabling the automobile.

Additional features and advantages of the present system and method are illustrated in the accompanying drawings and are described below.

### BRIEF DESCRIPTION OF THE DRAWINGS

FIG. 1 illustrates a memory, a voltage regulator driver, and programmable voltage regulator in accordance with one embodiment of the present invention.

FIG. 2 illustrates details of the voltage regulator driver of FIG. 1 in accordance with one embodiment of the present invention.

FIG. 3 is a flowchart illustrating a method in accordance with one embodiment of the present invention.

FIG. 4 schematically illustrates a system in accordance with another embodiment of the present invention.

Additional details and features of embodiments of the present invention will be apparent from these drawings and the following detailed description, in which like elements are labeled with like numbers.

### DETAILED DESCRIPTION

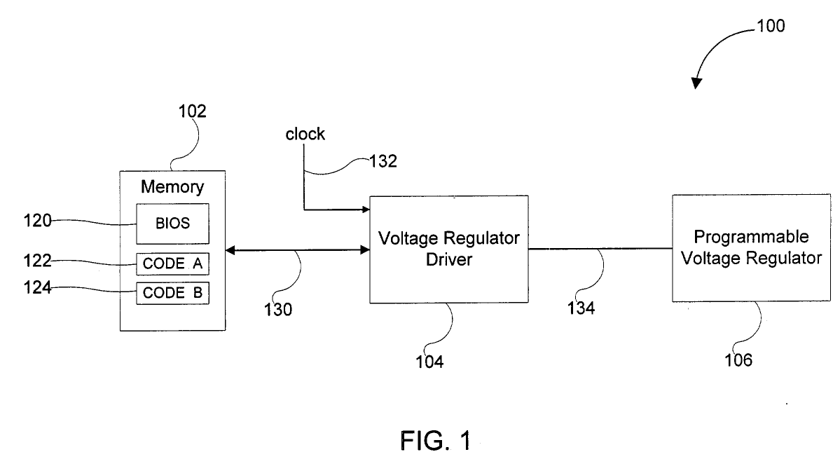

FIG. 1 illustrates a system 100 comprising a memory 102, a voltage regulation driver 104, and programmable voltage regulator 106, in accordance with one embodiment of the present invention. Pursuant to one aspect of the invention, the system 100 may comprise a part of a motherboard (not shown), such as a personal computer motherboard.

The memory 102 may comprise a non-volatile memory and includes BIOS 120, code A 122, and code B 124 stored therein. The memory 102 may also contain other software and data files (not shown), such a suitable operating system. The code A 122 may comprise a base seed number and the code B 124 may comprise a static number, such as a unique manufacturer ID number. Code A 122 and code B 124 are used as described below for security purposes. In one embodiment, the code A 122 comprises a 64-bit number and the code B 124 comprises a 16-bit number. The number of bits used to form code A 122 and code B 124 may vary, however. In another embodiment, the code A 122 is not stored at the memory 102, but is instead read from the voltage regulator driver 104.

The voltage regulator 104 is coupled to the memory 102 by at least one bi-directional bus 130 at one input pin thereof and receives a clock signal via a clock bus 132. The bus 130, in one embodiment, comprises an SMBus operable to permit data exchange between the voltage regulator and the memory 102 in accordance with SMBus protocol. Other suitable configurations of the bus 130 may alternatively be employed.

In one embodiment, the voltage regulator driver 104 outputs a voltage regulation signal to the programmable voltage regulator 106 along line 134. The programmable voltage regulator 106 is conventional.

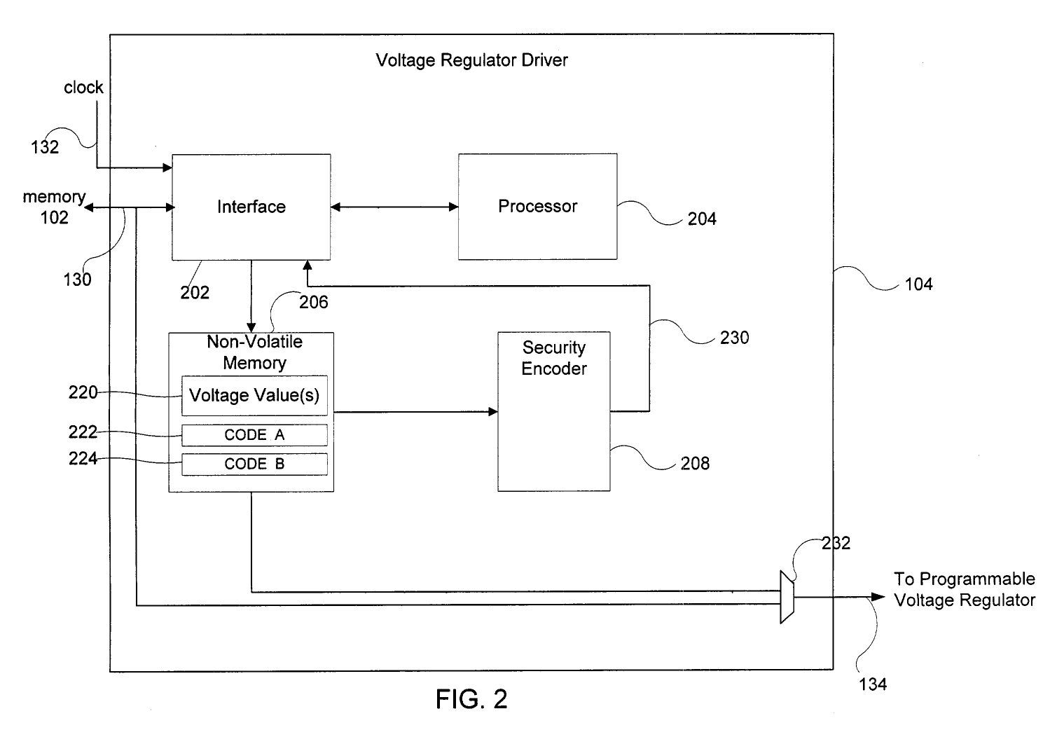

FIG. 2 illustrates details of one example embodiment of the voltage regulator driver 104 shown in FIG. 1. As shown, the voltage regulator driver 104 generally includes an interface 202, a processor 204, a non-volatile memory 206, and a security encoder 208. The interface 202, in one embodiment, comprises an SM (System Management) bus, or SMBus compatible interface. An SMBus is a bus used for communicating system requirements. An SMBus may be used, for example, to send charging requirements to a CPU (Central Processing Unit).

The processor 204 may comprise a SMBus command processor. The non-volatile memory 206 may comprise parallel EEPROM (electrically erasable programmable read-only memory) memory and includes voltage values 220. The interface 202 and the processor 204 are conventional and example ones of these components are found in voltage regulator drivers sold by Philips Electronics North America Corporation under product designation PCA 8550 and by Fairchild Semiconductor Corporation under the product designations FM 3560 and FM 3570. Additional details regarding embodiments of these components are disclosed in U.S. Provisional Patent Application No. 60/337,191, the disclosure of which is incorporated herein

In accordance with one embodiment of the present invention, the non-volatile memory 206 also includes code A 222 and code B 224, which correspond or are identical to the code A 122 and code B 124 (FIG. 1), respectively, of the memory 102. In normal operation, a first code A 222 is stored at the memory 206 and a subsequent, or new, code A 222 is written to the memory 206 by the BIOS 120 (FIG. 1). The code B 224 is permanently programmed into the memory 206 such that the code B 224 cannot be read or written with respect to the memory 206.

In a specific example embodiment, the BIOS 120 (FIG. 1) may write the code A 222 into the memory 206 as follows via the bus 130. The BIOS 120 first presents a valid START condition to start the cycle, followed by a device address byte with a read-write bit set to zero. On receiving a valid device address, the voltage regulator driver 104 issues an ACK (Acknowledgement) pulse. The BIOS 120 then sends a write seed number command byte for which the voltage regulator driver 104 issues an ACK pulse. The BIOS 120 then sends a byte-count byte indicating eight bytes of seed data will be send. The voltage regulator driver 104 issues an ACK pulse in response for the byte-count byte. The BIOS then issues eight bytes of seed data. For each byte thus received, the voltage regulator driver 104 issues an ACK pulse. After receiving the last ACK pulse, the BIOS 120 issues a stop condition at which point the voltage regulator driver 104 writes the received seed code A 222 into the memory 206 (FIG. 2).

With continued reference to FIG. 2, the voltage regulator driver 104 also includes a security encoder 208, which may comprise a hardware entity and performs a mathematical, or other, operation on the code A 222 and the code B 224 to generate a security code at output line 230. The mathematical operation may be the addition, subtraction, multiplication of code A 222 and code B 224. Of course, a wide variety of other suitable operations that output a security code on the line 230, which is based on or depends on both code A 222 and code B 224 may also be employed.

The voltage regulator driver 104 also may include multiplexer (mux) 232 disposed between the output line 134 of the voltage regulator driver 104, the input line 130 and the memory 206.

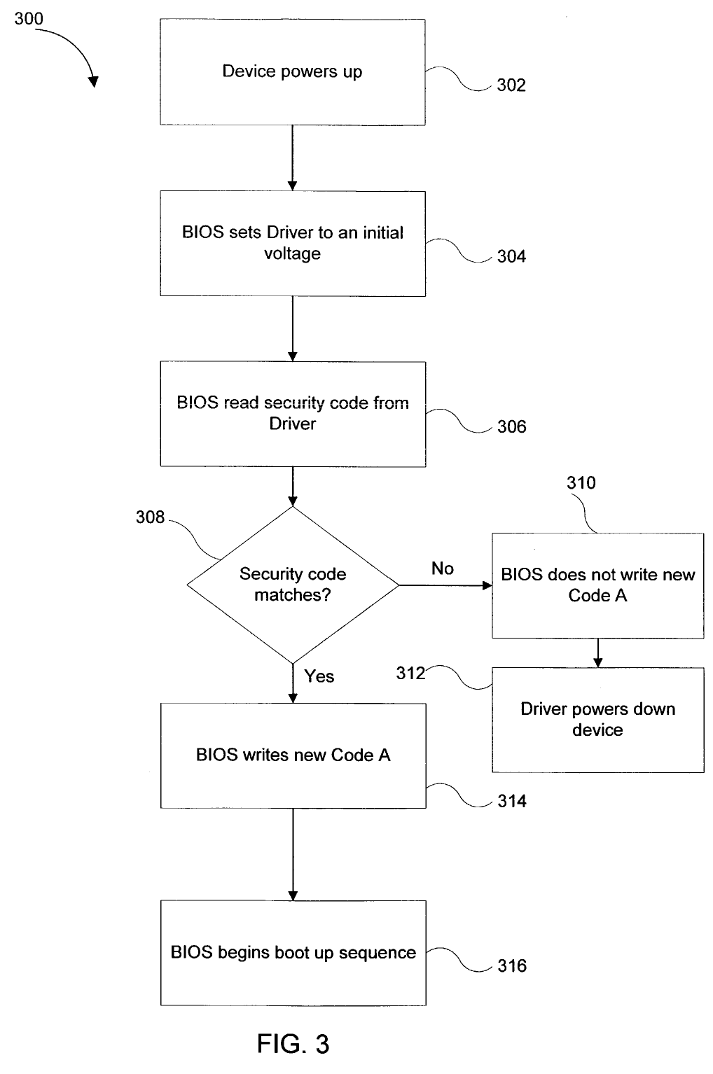

FIG. 3 illustrates a flowchart 300 that depicts a method in accordance with one embodiment of the present invention. In step 302, the device, such as an associated personal computer or other programmable system, powers up. In step 304, the BIOS 120 (FIG. 1) sets the voltage regulation driver 104 to an initial voltage level. Step 304 is optional.

Next the BIOS 120 (FIG. 1) reads a first security code from the voltage regulator driver 104, pursuant to step 306. In particular, the security encoder 208 (FIG. 2) reads code A 222 and code B 224 from the memory 206 over line 207. The security encoder 208 then generates the first security code based on a combination, such as a mathematical combination, or an amalgamation of the code A 222 and the code B 224 stored at the memory 206 of the driver 104. The resulting first security code is then read from the driver 104 by the BIOS 120 via the interface 202 and the bus 130.

In one embodiment, the BIOS 120 may access the security encoder 208 via the interface 202 using conventional SMBus operations as SMB bus accesses. The SMBus accesses to the security block may be of block-read/write type.

Next, pursuant to step 308, the BIOS 120 determines whether the first security code read from the voltage regulator driver 104 matches a second security code generated by the BIOS 120. The BIOS 120 generates the second security code by combining the code A 122 and the code B 124 using the same operation in which the security encoder 208 combines code A 222 and code B 224. In one embodiment, the first security code matches the second security code if the first security code equals the second security code.

In an alternate embodiment, the BIOS 120 does not read the code A 122 from the memory 102, but instead reads the code A 222 from the driver 104. The BIOS 120 then generates the second security code by combining the code A 222 from the driver 104 and the code B 124 stored at the memory 102 using the same operation in which the security encoder 208 combines code A 222 and code B 224.

Pursuant to a specific embodiment, the BIOS 120 may read the code 222 from the driver 104 using SMBus commands and protocol as follows. The BIOS 120 initially starts the cycle by presenting a valid start condition followed by a device address byte with read-write bit set to zero. Upon receiving a valid device address, the driver 104 issues an ACK pulse. This is followed by a read seed number command byte for which the driver issues an ACK pulse. The BIOS 120 then re-issues a start condition followed by a device address byte with read-write bit set to one. On receiving a valid device address, the driver 104 issues an ACK pulse. The driver 104 is now ready to readout the seed data (i.e., the code 222) and provides a byte-count byte indicating the number of bytes (e.g., 8 bytes) of seed data to be readout. Upon receiving the byte-count byte, the BIOS 120 issues an ACK pulse. In response, the driver 104 issues the seed data. For each byte of data received by the BIOS 120, the BIOS 120 issues an ACK pulse, except for the last byte of data, for which the BIOS issues a “no ACK” pulse and issues a stop condition to terminate the read cycle.

The BIOS 120 may read the security code generated at the driver 104 in a similar manner as reading the code 222 from the driver 104, except as follows. Instead of issuing by read seed number command byte, a read security code command byte is issued by the BIOS 120. In some embodiments, a first bit of the security code is always “1” and may, therefore, be ignored. Accordingly, the code 222 and a security code may be read from the driver 104 by the BIOS 120 using SMBus block read commands. The BIOS 120 may write a new code 222 to the driver 104 using an SMBus block write command.

If the first security code read from the voltage regulator driver 104 does not match the second security code generated by the BIOS 120, then execution proceeds to step 310, else execution proceeds to step 314. At step 310, the BIOS 120 does not write a new code A or any other data to the memory 206 and execution proceeds to step 312.

At step 312, the voltage regulator driver 104 powers down the device. Thus, in this manner, if the BIOS 120 of the motherboard is not of an authorized manufacturer, the BIOS 120 is very likely to not include a code A 122 and a code B 124. Thus, the BIOS 120 will not likely be able to produce the same security code as driver 104 and will, therefore, not function with the voltage regulator driver 104.

If, however, the first security code read from the voltage regulator driver 104 matches the second security code generated by the BIOS 120, then execution proceeds to step 314. At step 314, the BIOS 120 generates a new code A 122, such as by using a random number generator algorithm, and writes the new code A into the memory 206 as code A 222 and writes the new code A into the memory 102 as code A 122. In this manner, the security code is different for each boot. Lastly, pursuant to step 316, the BIOS 120 may begin, or continue, normal boot up sequence.

As used herein, “random number” includes truly random numbers, pseudo-random numbers, quasi-random numbers, and the like. Thus, the random number generator algorithm employed by the BIOS may comprise a generator for creating truly random numbers, pseudorandom numbers, quasi-random numbers, and the like.

In a subsequent boot up attempt, the new code A 122 and the new code A 222 will be used in place of the previous code A 122 and the previous code A 222. In an embodiment where the new code A 122 and the new code A 222 are generated by a random number generator, it is highly likely that the new code A 122 and the new code A 222 are different from the previous code A 122 and the previous code 222. Thus, when the new code A 122 is combined with the code B 124, the resulting new security code is highly likely to differ from the previous security code based on the previous code A 122 and the code B 124.

Accordingly, the resulting security code comprises a rolling code in that the security code changes with each boot attempt.

In another embodiment, the BIOS 120 is programmed to poll the voltage regulator driver 104 for a security code at regular intervals. If the appropriate code is not read by the BIOS 120, the BIOS 120 causes the system 100 to shut down or refuse to boot at power up.

The present invention is not limited to use with a voltage regulator driver and motherboard combination. For example, the present invention may be implemented in a software key device for providing a changing, or rolling, security code for preventing unlicensed usage of a software application. Similarly, this type of implementation may be used in connection with game cartridges associated with electronic games. In another embodiment, the present invention may be implemented as a removable card to function as a disable mechanism for portable electronic devices so to render the portable electronic devices inoperable without the removable card inserted therein having correct codes stored therein.

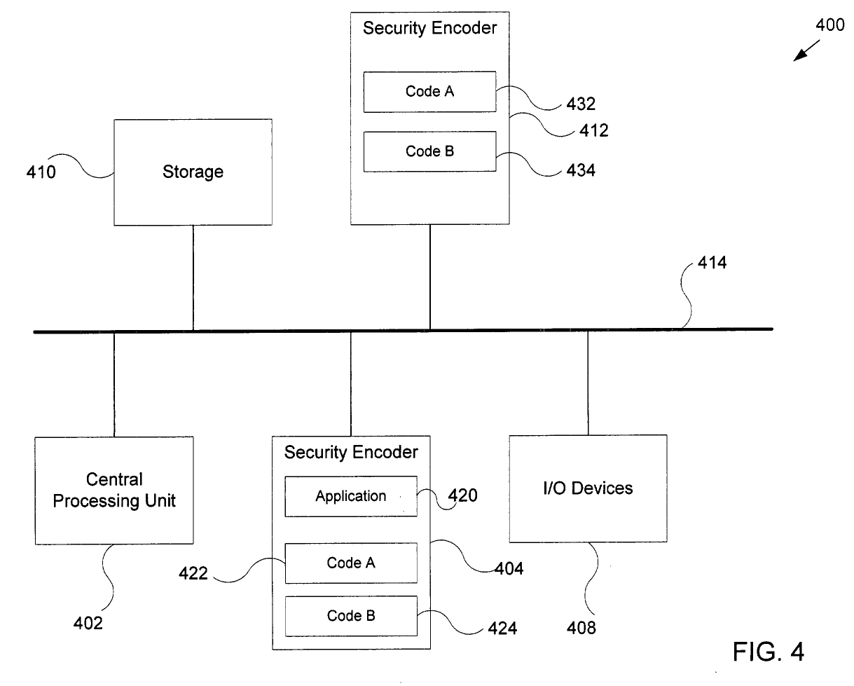

FIG. 4 illustrates a system 400 in accordance with other embodiments of the present invention. The system 400 may comprise a personal computer, a portable electronic device, an engine control unit, an electronic game console, or the like.

As shown, the system 400 generally includes a central processing unit 402, a memory 404, input/output devices 406, storage 410, and security encoder 412, coupled by at least one bus 414. The central processing unit 402 may comprise any of a variety of suitable conventional data processors, which are well known to those skilled in the art. The memory 404 may comprise volatile memory, non-volatile memory, or both. A software application 420 is shown as being stored at the memory 404. Code A 422 and code B 424 may also be stored at the memory 404. The code A 422 may comprise a seed number and the code B may comprise a static number.

The storage 410 is optional and may comprise, for example, a hard disk drive or the like. The security encoder 412 may be configured similar or identical to the driver 104 (FIG. 2) described above and stores code A 432 and code B 434, where code A 432 comprises a seed number and code B 434 comprises a static number.

In operation, according to one embodiment, the security encoder 412 comprises a software key. The application 420, in this embodiment, only functions normally when the security encoder 412 is present and generates a security code that matches a security code generated by the application 420. In this embodiment, the application 420 generates a first security code based on the static code B 424 stored at the memory 404 and the seed code 422 stored at the memory 404. Alternately, the application 420 generates the first security code based on the static code B 424 stored at the memory 404 and the seed code 432 stored at the security encoder 412.

The security encoder 412 generates a second security code based on the code A 432 and the code B 434. The application 420 reads the second security code from the security encoder 412. If the application 420 determines that the first and second security codes match, the application 420 continues normal operation, otherwise, the application 420 ceases normal operation.

Further, the application 420 includes a random number generator algorithm that generates a random number of predetermined length. If the application 420 determines that the first and second security codes match, the application 420 generates a random number and writes the random number to the security encoder 412 as code A 432. In subsequent operations, the security encoder 412 generates the second security code using the new random number stored at the security encoder 412 as code A 432.

Accordingly, in this embodiment, the present system and method may also be used to prevent unlicensed software use. For example, if the application 420 does not generate a security code that matches the security code generated at the security encoder 412, the application 420 may not be licensed for use with that security encoder 412 and may cease operation.

With respect to electronic games, the present system and method may protect game manufacturers from software theft. Many electronic game systems comprise a game console and a removable game cartridge. In this embodiment, the security encoder 412 may comprise a portion of a removable game cartridge and the other components of the system 400 may comprise portions of a game console. The application 420 may comprise an initialization application for the removable cartridge. Thus, the cartridge is initially configured to include a static number and a first seed number. The cartridge then generates a first security code based on the static number and the first seed number. The console then reads the first security code from the cartridge and determines whether the first security code matches a second security code calculated at the console based on a static number stored at the console and a seed number. If the first and second security codes do not match, the console ceases execution of the game stored at the cartridge. If the first and second security codes do match, however, the console writes a new seed number to the cartridge and continues normal operation with respect to the cartridge.

With respect to portable electronic devices, the present system and method may protect manufacturers from third-party development and usage of peripherals made specifically for use on their products (e.g., cellular telephone battery chargers). In this embodiment the manufacturer's authorized base product may comprise the security encoder 412 and the peripheral may comprise the other components of the system 400. Alternately, the peripheral may comprise the security encoder 412 and the authorized base product may comprise the other components of the system 400.

In another embodiment, the present system and method may be implemented as an anti-theft mechanism, such as for an automobile. Pursuant to this embodiment, the security encoder 412 may comprise a removable card and the other components of the system 400 may comprise an engine control unit (ECU) of the automobile. The ECU may read a security code card matches a security code generated at the ECU when the automobile is started. If the security codes do not match, the ECU may cease the start operation or otherwise disable the automobile until the ECU reads a matching code from the removable card.

Although the invention has been described with reference to particular embodiments, the description is only an example of the invention's application and should not be taken as a limitation. Various other adaptations and combinations of features of the embodiments disclosed are within the scope of the invention.

What is claimed is:

1. An authenticating method, comprising:
storing a first number and a second number at a first device;
storing the first number and the second number at a second device;
generating a first code at the first device using the first and second numbers stored at the first device;
generating a second code at the second device using the first and second numbers stored at the second device;
determining whether the first code matches the second code;
generating a third number and storing the third number at the first and the second devices if the first code matches the second code.

2. The authenticating method according to claim 1, further comprising:
generating a third code at the first device using the first and third numbers stored at the first device;
generating a fourth code at the second device using the first and third numbers stored at the second device;
determining whether the third code matches the fourth code.

3. The authenticating method according to claim 1, wherein the third number comprises a random number.

4. The authenticating method according to claim 1, where the first device ceases to operate if the first code does not match the second code.

5. The authenticating method according to claim 1, wherein the determining whether the first code matches the second code is performed at the first device.

6. The authenticating method according to claim 1, wherein the first device comprises a motherboard.

7. The authenticating method according to claim 1, wherein the second device comprises a voltage regulator driver.

8. The authenticating method according to claim 1, wherein the determining whether the first code matches the second code is performed by a BIOS.

9. An authenticating method, comprising:
storing a first number at a first device;
storing the first number and a second number at a second device;
generating a first code at the first device using the first number stored at the first device and the second number stored at the second device;
generating a second code at the second device using the first and second numbers stored at the second device;
determining whether the first code matches the second code;
generating a third number and storing the third number at the second device if the first code matches the second code.

10. The authenticating method according to claim 10, further comprising ceasing a boot operation if the first code does not match the second code.

11. The authenticating method according to claim 10, wherein the first device reads the second number and the second code from the second device and performs the determining whether the first code matches the second code.

12. The authenticating method according to claim 10, wherein the determining whether the first code matches the second code is performed by a BIOS.

13. The authenticating method according to claim 10, wherein the second device comprises a voltage regulator driver.

14. An authenticating method, comprising:
generating a first code at a first device using first and second numbers stored at the first device;
generating a second code at the second device using the first and second numbers stored at the second device;
reading the second code from the second device by the first device;
determining at the first device whether the first code matches the second code;
generating a third number at the first device and storing the third number at the second device if the first code matches the second code.

15. The authenticating method according to claim 14, further comprising:
generating a third code at the first device using the first and third numbers;
generating a fourth code at the second device using the first and third numbers;
determining at the first device whether the third code matches the fourth code.

16. The authenticating method according to claim 14, wherein the third number comprises a random number.

17. The authenticating method according to claim 14, where the first device ceases to operate if the first code does not match the second code.

18. The authenticating method according to claim 14, wherein the determining whether the first code matches the second code is performed at the first device.

19. The authenticating method according to claim 14, wherein the first device comprises a motherboard.

20. The authenticating method according to claim 14, wherein the second device comprises a voltage regulator driver.

21. The authenticating method according to claim 14, wherein the determining whether the first code matches the second code is performed by a BIOS.
